(19) United States
(12) Patent Application Publication
(10) Pub. No.: US 2026/0017314 A1
(43) Pub. Date: Jan. 15, 2026

(54) METHOD AND SYSTEM FOR AUTOMATED VIDEO TAG GENERATION AND APPLICATION

(71) Applicant: JPMorgan Chase Bank, N.A., New York, NY (US)

(72) Inventors: Peter Plantinga, Columbus, OH (US); Chandra Dhir, San Jose, CA (US); Rohit Nilekar, Edison, NJ (US); Jerome Utley, Brooklyn, NY (US)

(73) Assignee: JPMorgan Chase Bank, N.A., New York, NY (US)

(21) Appl. No.: 18/772,664

(22) Filed: Jul. 15, 2024

(51) Int. Cl. G06F 16/45

(52) U.S. Cl. CPC G06F 16/45

(57) ABSTRACT

Aspects of the subject disclosure may include, for example, obtaining a first set of tags and a first set of descriptions associated with a set of content items, causing an LLM to generate a plurality of tags based on the first set of tags and the first set of descriptions, resulting in a second set of tags, wherein the second set of tags includes the first set of tags and the plurality of tags, and causing the LLM to apply one or more tags from the second set of tags to one or more content items based on information regarding the one or more content items. Other embodiments are disclosed.

### FIELD OF THE DISCLOSURE

The subject disclosure relates to automated tag generation and application for content items, such as video content, audio content, text-based content, etc.

### BACKGROUND

Video libraries are vast repositories of visual content that can store hundreds, thousands, and even millions of videos for user access. Typically, metadata, such as tags and descriptions are used to categorize and organize these digital assets, making it easier for viewers to find specific content or discover new related material. In some video libraries, however, the majority of videos lack proper tags, which can make it difficult for viewers to search or browse through the collection. In fact, in certain video libraries, only about five to ten percent of the videos are associated with tags. Furthermore, the few tags that do exist do not tend to follow a consistent format, which can make it challenging for users to identify relevant content or discover connections between different videos. For instance, two videos on the same topic might be tagged differently, resulting in misses where videos with similar themes or topics are not linked together. There are various tag generation tools that are available on the Internet, but these tend to operate on the title, descriptions, or keywords associated with a video rather than on the actual content (e.g., audio, visual elements, transcripts, etc.) of the video, which can lead to inaccurate or incomplete tagging.

### SUMMARY OF THE DISCLOSURE

One or more aspects of the subject disclosure include a device, comprising a processing system including a processor, and a memory that stores executable instructions that, when executed by the processing system, facilitate performance of operations. The operations can include obtaining a first set of tags and a first set of descriptions associated with a set of content items. Further, the operations can include causing a large language model (LLM) to generate a plurality of tags based on the first set of tags and the first set of descriptions, resulting in a second set of tags, wherein the second set of tags includes the first set of tags and the plurality of tags. Further, the operations can include causing the LLM to apply one or more tags from the second set of tags to one or more content items based on information regarding the one or more content items.

One or more aspects of the subject disclosure include a non-transitory machine-readable medium, comprising executable instructions that, when executed by a processing system including a processor, facilitate performance of operations. The operations can include receiving a first set of tags and a first set of descriptions associated with a set of videos. Further, the operations can include instructing an LLM to generate a plurality of tags based on the first set of tags and the first set of descriptions, resulting in a second set of tags, wherein the second set of tags includes the first set of tags and the plurality of tags. Further, the operations can include instructing the LLM to apply one or more tags from the second set of tags to one or more videos based on information regarding the one or more videos.

One or more aspects of the subject disclosure include a method. The method can comprise obtaining, by a processing system including a processor, a first set of tags and a first set of descriptions associated with a set of content items. Further, the method can include causing, by the processing system, a first LLM to generate a plurality of tags based on the first set of tags and the first set of descriptions, resulting in a second set of tags, wherein the second set of tags includes the first set of tags and the plurality of tags. Further, the method can include causing, by the processing system, a second LLM to apply one or more tags from the second set of tags to one or more content items based on information regarding the one or more content items.

### BRIEF DESCRIPTION OF THE DRAWINGS

Reference will now be made to the accompanying drawings, which are not necessarily drawn to scale, and wherein:

FIG. 1A illustrates an example environment for facilitating automated tag generation and application for content, such as videos, in accordance with various aspects described herein.

FIG. 1B is a diagram of an example AI architecture, which can be used to facilitate training or pre-training of one or more LLMs, in accordance with various aspects described herein.

FIG. 1C is a diagram of an example transformer model, a portion or an entirety of which can serve as a functional building block of one or more LLMs, in accordance with various aspects described herein.

FIG. 2A illustrates an example process for tag generation and application involving the environment of FIG. 1A, in accordance with various aspects described herein.

FIG. 2B illustrates an example prompt for instructing an LLM to generate tags, in accordance with various aspects described herein.

FIG. 2C illustrates an example curated list of tags that includes pre-existing tags and additional tags generated by the LLM.

FIG. 2D illustrates an example prompt for instructing an LLM to select/apply tags for a video, in accordance with various aspects described herein.

FIGS. 2E to 2G illustrate various examples of selected/applied tags for different videos based on their titles and descriptions.

FIG. 3 depicts an illustrative embodiment of a method in accordance with various aspects described herein.

FIG. 4 is a block diagram of an example, non-limiting embodiment of a computing environment in accordance with various aspects described herein.

### DETAILED DESCRIPTION

The subject disclosure generally relates to illustrative embodiments of an end-to-end (E2E) platform that is capable of automatically generating relevant (e.g., list(s) of) tags for videos in a video library, and applying the tags to some or all of the videos. In exemplary embodiments, the automated platform may be capable of collecting existing tags that are associated with a set of videos to identify patterns or themes, obtaining video descriptions from a random sample of the videos to determine the type of content therein, employing an LLM to analyze the collected tags and video descriptions to auto-generate a list of suitable tags based on the analysis, and utilizing an LLM (e.g., the same or a different LLM) to automatically assign the generated tags to individual videos based on their titles and/or descriptions. In this way, video content may be used to both generate an appropriate set of tags and to apply such tags to individual videos, which helps form links or relationships between videos that include similar content and promotes overall video discoverability.

Exemplary embodiments described herein advantageously provide for artificial intelligence (AI)-powered tag generation and application in which the system learns from existing data and adapts to new content, thereby enabling more accurate and consistent video tagging. While embodiments of the automated platform are described in relation to tag generation and application for video-based content, it is to be understood and appreciated that the automated platform may additionally, or alternatively, perform tag generation and application for other types of content, such as audio-based content, image-based content, text-based content, three-dimensional (3D) content, interactive content (e.g., games), virtual reality (VR)/augmented reality (AR) content, live events or broadcasts, and/or the like.

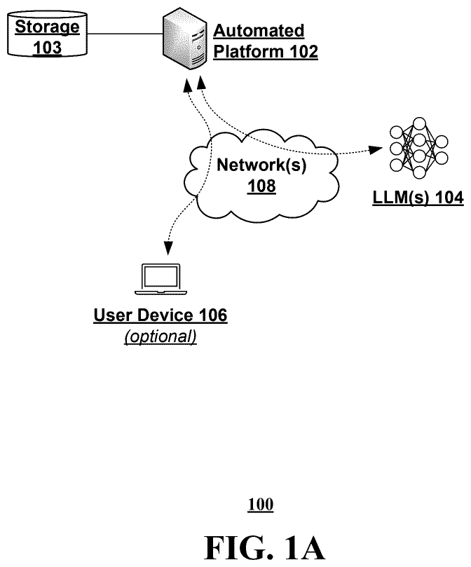

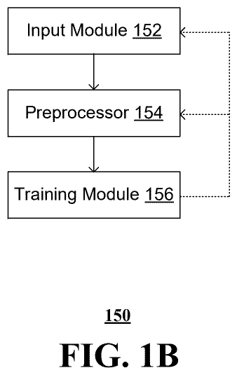

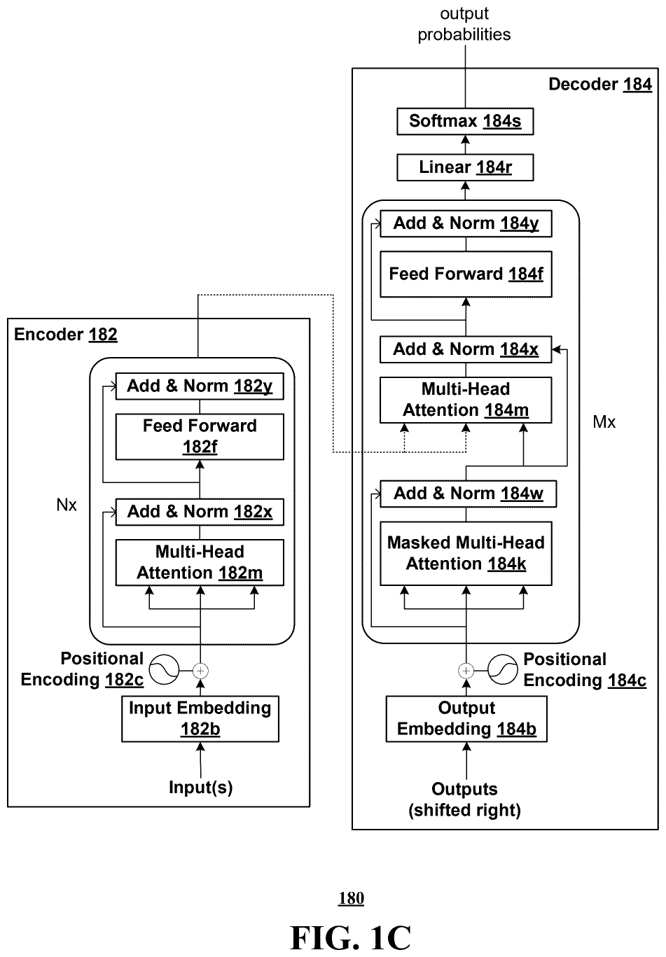

Referring to FIG. 1A, an environment 100 may include an automated platform 102, one or more LLMs 104, (optionally) a user device 106, and network(s) 108. In various embodiments, the automated platform 102 may function as a tag generation and application control system. In one or more embodiments, the automated platform 102 may include one or more computing devices that are capable of accessing content (e.g., videos, audio, text, etc.) in a storage 103 (e.g., a database or file system), and performing one or more operations relating to the content. In exemplary embodiments, the operations may include converting videos into audio format, converting audio into text, and/or leveraging (e.g., generative) AI capabilities of the LLM(s) 104 to generate data (e.g., tags) based on the text and to perform other tasks relating to the data (e.g., applying tags to videos). In certain embodiments, the automated platform 102 may be configured with one or more AI agents for interacting with the LLM(s) 104 to facilitate repeated/recursive functions relating to data generation and/or the performance of the other tasks, which enables E2E tag generation and application with minimal to no user input.

The one or more LLMs 104 may include trained and/or pre-trained transformer-based models, such as those described below with respect to FIG. 1B. A given LLM 104 may be implemented with one or more interfaces, such as application programming interface(s) (APIs), for external access to the LLM 104. In exemplary embodiments, the automated platform 102 may interact with the LLM 104 via API calls over the network(s) 108, by submitting inputs via API requests and obtaining outputs via API responses.

The user device 106 may include one or more computing devices that are capable of inputting/outputting user inputs and communicating information with other devices/systems over the network(s) 108. The user device 106 may be or may include a desktop computer, a laptop computer, a tablet computer, a mobile phone, a wearable device (e.g., a smart wristwatch, a pair of smart eyeglasses, media-related gear (e.g., augmented reality (AR), virtual reality (VR), or mixed reality (MR) glasses and/or headset/headphones)), any other similar type of device, any other different type of device, or a combination of some or all of these devices.

The network(s) 108 may facilitate communications between the automated platform 102 and the LLM(s) 104 and/or the user device 106. The network(s) 108 may include one or more wired and/or wireless networks, such as, for instance, a cellular network (e.g., a 4G network, a 5G network, or a higher generation network), a public land mobile network (PLMN), a metropolitan area network (MAN), a telephone network (e.g., the Public Switched Telephone Network (PSTN)), a local area network (LAN), a wide area network (WAN), a private network, an ad hoc network, an intranet or the Internet, a fiber optic-based network, a cloud computing network, any other similar network, or a combination of some or all of these networks and/or other types of networks.

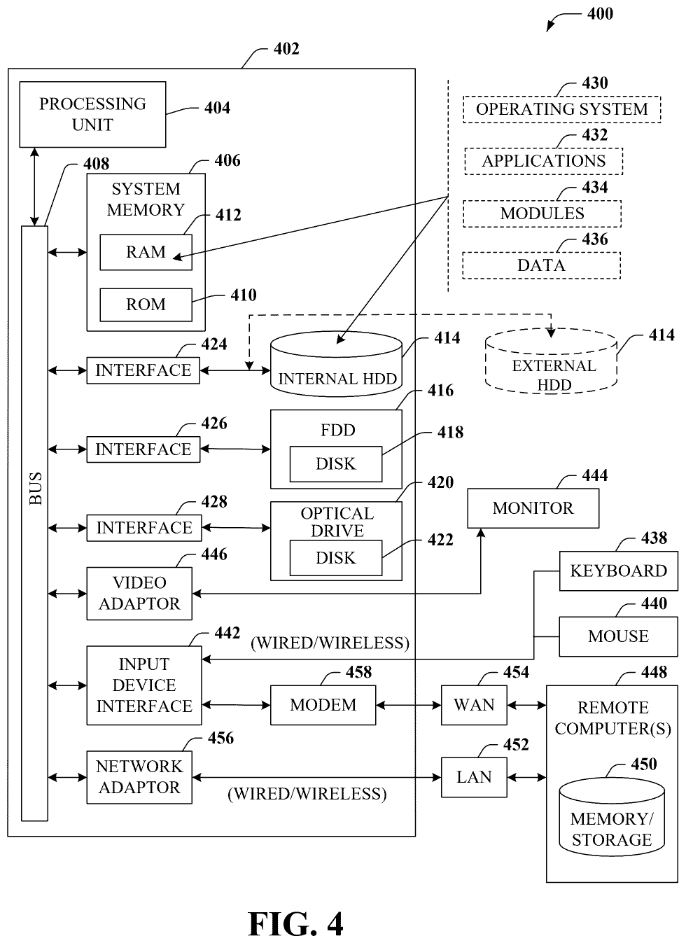

Referring to FIG. 1B, an example AI architecture 150, which can be used to facilitate training and/or pre-training of LLMs (e.g., LLM(s) 104 of FIG. 1A), may include an input module 152, a preprocessor 154, and a training module 156. Some or all of these modules, which may be referred to as programs, processors, or agents, may be realized based on execution of instructions or data by one or more processors of a computing (or machine learning (ML)) system, such as the computing (or ML) system 400 of FIG. 4 (described in more detail below).

The input module 152 may allow for input of (e.g., user-provided) data, such as datasets, parameters (e.g., weights, biases, and/or the like), etc., that can be used to train models and/or obtain predictions from models. In some cases, datasets may be labeled and may include inputs (e.g., observed or measured values) and known output data. Labeled datasets may facilitate supervised (or guided) learning.

Although not shown, the AI architecture 150 may include a library of ML models or algorithms, such as, for instance, one or more classifiers (e.g., a naïve Bayes classifier or the like), one or more support vector machines, one or more artificial neural networks (e.g., transformer neural networks, convolutional neural networks, and/or the like), one or more learned decision trees, and so on. Each of the ML algorithms may be associated with various parameters.

The preprocessor 154 may be equipped with one or more preprocessing algorithms that are configured to prepare input datasets for processing by the training module 156. Such preprocessing may include discretization (where values are binned or converted into nominal values), component analysis, data estimation, feature selection, feature extraction (e.g., dimensionality reduction, data removal, statistical analysis, threshold-based filtering, etc.), data interpolation, and/or the like.

The training module 156 may be configured to train and evaluate ML models. As an example, the training module 156 may be configured to perform unsupervised learning and/or supervised learning based in input datasets. In exemplary embodiments, the training module 156 may be capable of training and/or evaluating the performance of multiple models in parallel. In one or more implementations, the training module 156 may, despite operating on multiple ML models in parallel, train and evaluate the various ML models individually. In some implementations, the training module 156 may be capable of combining the procedure outcomes of multiple models to derive an aggregate outcome. Model evaluation or validation may involve a comparison of model outputs to known outputs or an analysis of model outputs relative to desired metrics.

In exemplary embodiments, certain processing techniques may be employed to generate usable data sets for feeding into the AI architecture 150 to train deep learning neural network model(s) to output predictions. Although not shown, the AI architecture 150 may include additional functional modules, such as those for gathering performance results and presenting (e.g., displaying) data regarding the results. While various components, modules, etc. may have been illustrated in FIG. 1B as separate components, modules, etc., it will be appreciated that multiple components, modules, etc. can be implemented as a single component, module, etc., or a single component, module, etc. can be implemented as multiple components, modules, etc. Additionally, functions described as being performed by one component, module, etc. may be performed by multiple components, modules, etc., or functions described as being performed by multiple components, modules, etc. may be performed by a single component, module, etc.

Referring to FIG. 1C, an example transformer model 180 (a portion or an entirety of which can serve as a functional building block of one or more LLMs (e.g., LLM(s) 104 of FIG. 1A)) may include an encoder 182 and a decoder 184. The encoder 182 may include an input embedding block 182b, a positional encoder 182c, and a series of (i.e., multiple (Nx)) identical layers that each has a multi-head attention block 182m and a feed forward block 182f. An input (e.g., text, such as a query or a prompt) may be converted into individual tokens (e.g., words, characters, etc.) that are fed into the input embedding block 182b. The input embedding block 182b may convert the tokens into continuous vectors, where each token is mapped to a high-dimensional space by way of a learned embedding matrix. The embedding matrix may be implemented in a lookup table or the like, where token indexes are associated with different vectors of a fixed size. The positional encoder 182c may derive fixed positional encodings or learned positional encodings to help capture positional information of tokens. Fixed positioning encodings may be generated using sinusoidal functions, where the different frequencies of sine/cosine functions correspond to unique positional encodings for the different positions in a given sequence. Learned positional encodings may be learned during training based on initially randomly chosen values that are optimized as part of the training process. In any case, the positional encodings may be combined with the input embeddings from the input embedding block 182b on an element-by-element basis, resulting in a processed input that may be fed into the series of layers. The processed input may be fed into the multi-head attention block 182m in the first layer. An addition (or residual connection) and normalization block 182x may operate on the processed input and the output of that multi-head attention block 182m. The output of the addition and normalization block 182x may be passed to the feed forward block 182f in that layer. An addition and normalization block 182y may operate on the output of the addition and normalization block 182x and the output of the feed forward block 182f. In essence, the multi-head attention block 182m of a given layer may enable the feed forward block 182f in that layer to model long term dependencies. Multi-head attention allows the model to simultaneously attend to different parts of the input sequence and weigh their importance based on the input sequence's internal relationships. This attention mechanism may be combined with the input sequence's representations to produce a new set of weighted representations. Iterating the identical layers allows the model to learn complex patterns and relationships in the data.

The decoder 184 may include an output embedding block 184b, a positional encoder 184c, and a series of (i.e., multiple (Mx)) identical layers that each has a masked multi-head attention block 184k, a multi-head attention block 184m, and a feed forward block 184f. An output (shifted right) may be converted into individual tokens that are fed into the output embedding block 184b. The output embedding block 184b may convert the tokens into continuous vectors. The positional encoder 184c may derive fixed positional encodings or learned positional encodings to help capture positional information of tokens. The processed output may be fed into the masked multi-head attention block 184k in the first layer. An addition and normalization block 184w may operate on the processed output and the output of that masked multi-head attention block 184k. The output of the addition and normalization block 184w may be passed to the multi-head attention block 184m in that layer. Output(s) from the encoder 182 may also be fed into the multi-head attention block 184m. An addition and normalization block 184x may operate on the output of the addition and normalization block 184w and the output of multi-head attention block 184m. The output of the addition and normalization block 184x may be passed to the a feed forward block 184f in that layer. An addition and normalization block 184y may operate on the output of the addition and normalization block 184x and the output of the feed forward block 184f. The output of the addition and normalization block 184y may may be passed to a linear layer 184r, which may transform that output into a higher-dimensional space. The output of the linear layer 184r may be fed into a softmax layer 184s, which may be a non-linear activation function that normalizes the output to a probability distribution to ensure that all values are non-negative and add up to 1. Iterating the identical layers allows the model to learn complex patterns and relationships in the data.

Various types of transformer-based LLMs may be constructed by “stacking” the identical layers of the encoder 182 and/or the decoder 184 in particular arrangements and in combination with additional refinements/components. A given LLM constructed as such may then be trained or pre-trained (e.g., using the AI architecture 150 of FIG. 1B, a similar AI architecture, a different AI architecture or a combination of some or all of these AI architectures) on a corpus of information and/or finetuned or instruction-tuned to analyze/generate data (e.g., text, audio, and/or images).

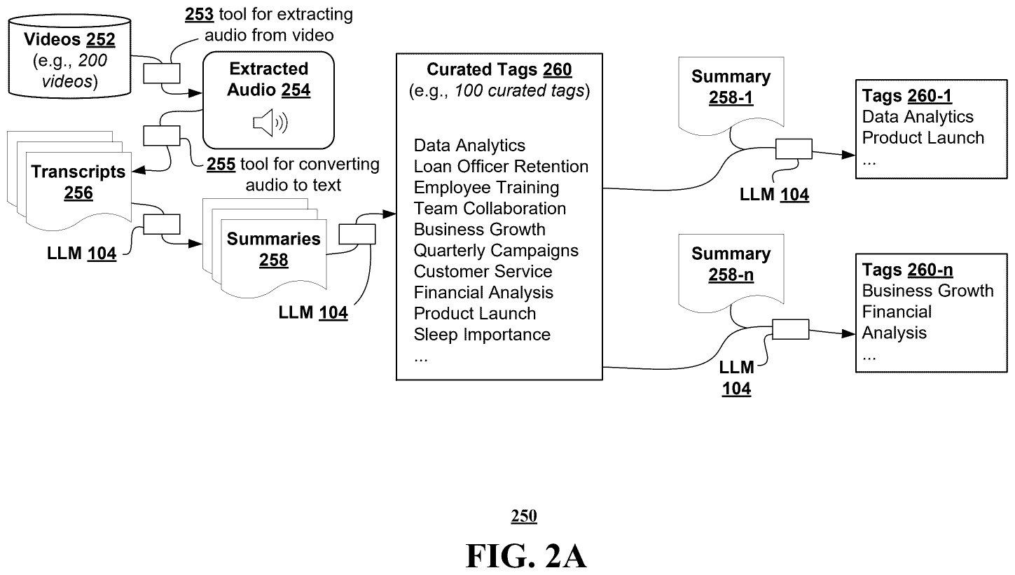

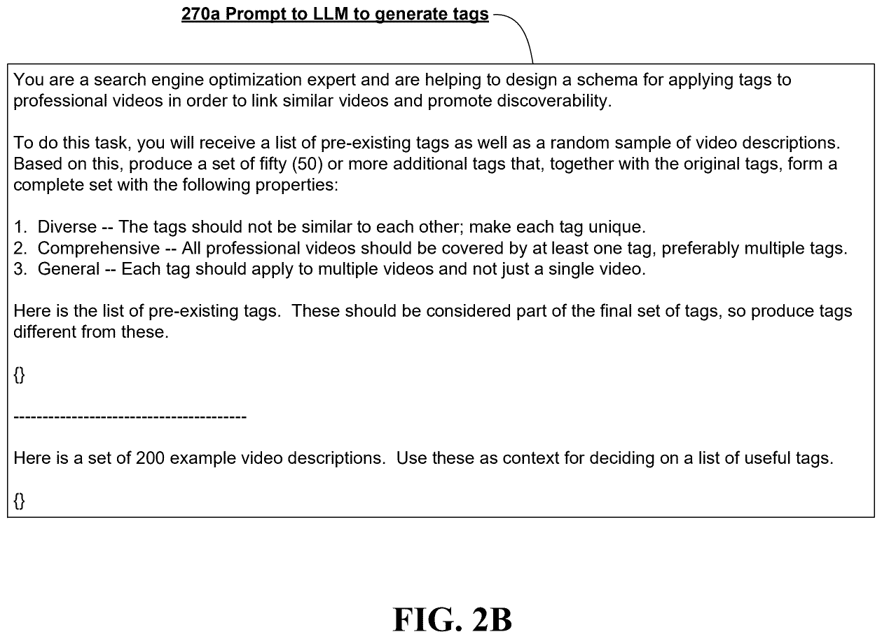

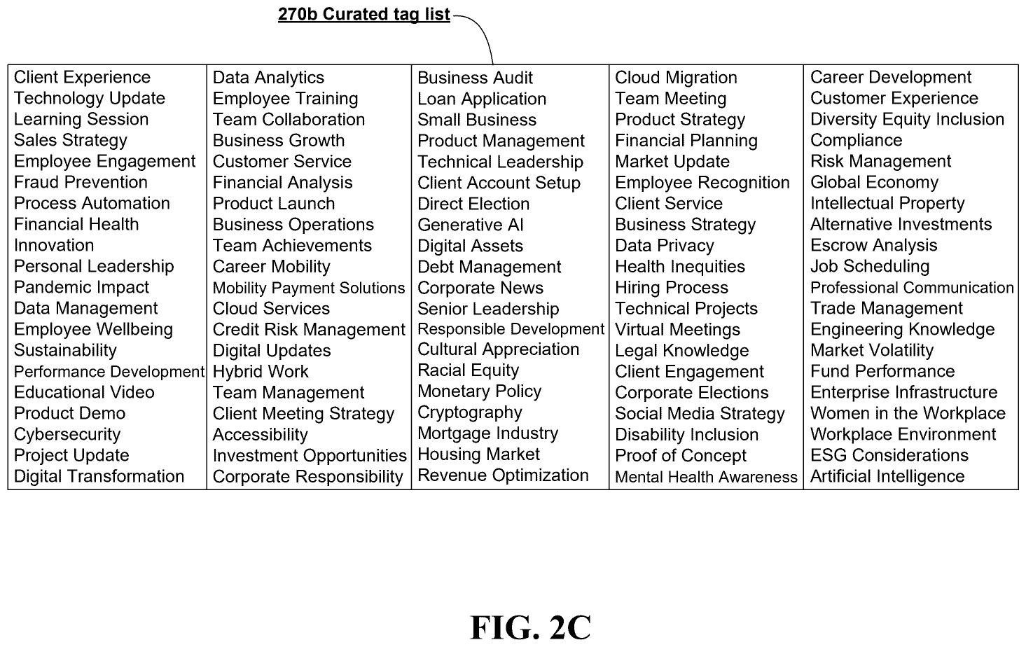

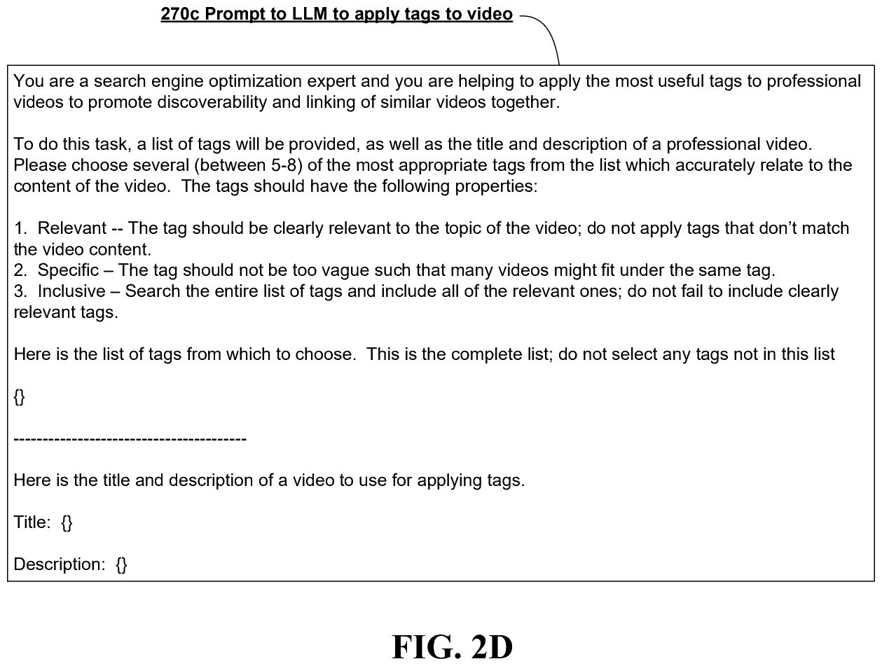

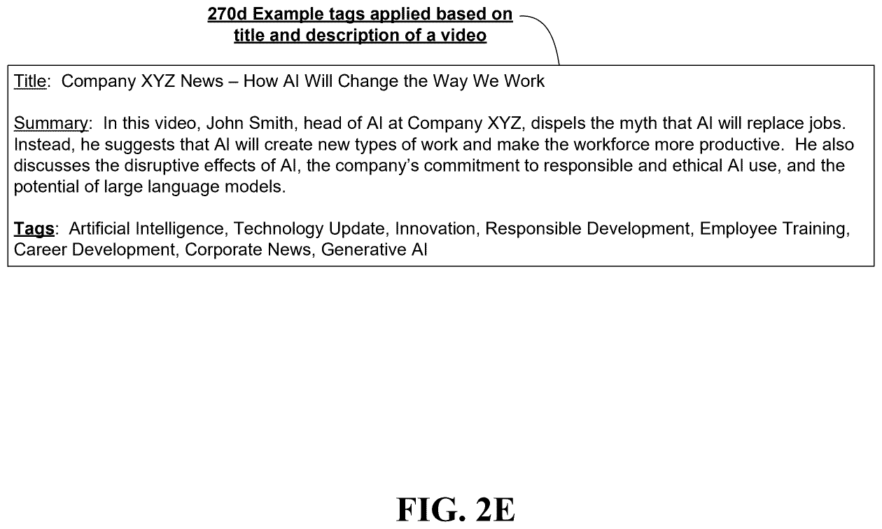

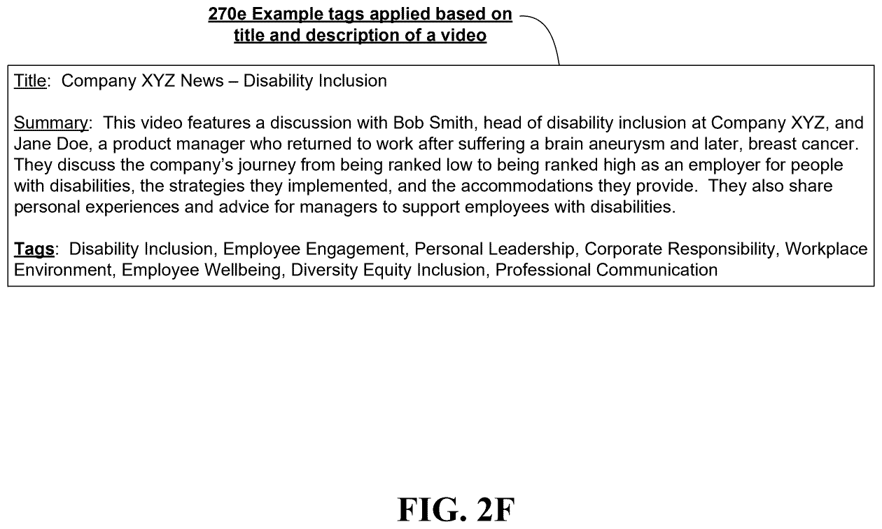

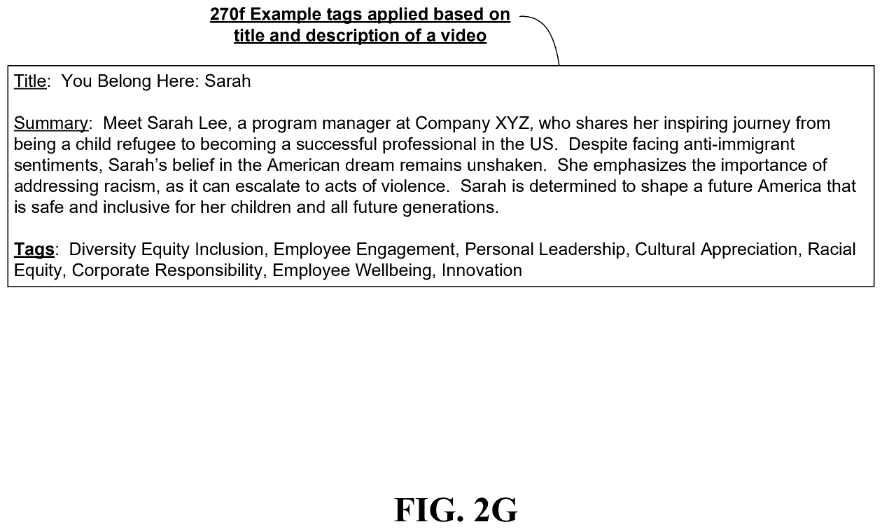

Referring to example process 250 in FIG. 2A, the automated platform 102 may convert videos—e.g., some or all of the videos, such as perhaps a random sample of two hundred videos or the like-into audio format 254. The conversion may be performed using a system, program, or tool (253) that is capable of processing video, audio, and/or other multimedia files or streams, and more particularly extracting audio from videos. The automated platform 102 may process the converted audio 254 to generate transcripts 256. This can involve the use of one or more natural language processing (NLP) techniques 255, such as speech-to-text (S2T) algorithm(s) (or automatic speech recognition (ASR) algorithm(s)), speech and language toolkit(s) (e.g., which may be built on top of open source tool(s) and include additional features and customizations), and/or machine learning-based approaches. In various embodiments, the automated platform 102 may generate the transcripts 256 using one or more techniques described in co-pending U.S. patent application Ser. No. 18/442,974, filed on Feb. 15, 2024 and entitled “SYSTEMS AND METHODS FOR CONTINUAL LEARNING FOR END TO-END AUTOMATIC SPEECH RECOGNITION” and/or co-pending U.S. patent application Ser. No. 18/439,788, filed on Feb. 13, 2024 and entitled “APPARATUSES AND METHODS FOR FACILITATING A TRANSCRIPT SUMMARIZATION WITH SPELLING CORRECTIONS,” each of which is incorporated by reference herein in its entirety. In one or more embodiments, the automated platform 102 may cause an LLM 104 to generate summaries 258 from the transcripts 256. This may involve prompting the LLM 104 to derive (e.g., short) descriptions of the videos based on the transcripts 256.

In one or more embodiments, the automated platform 102 may obtain a set of pre-existing tags (not shown) associated with a subset of the videos. The automated platform 102 may provide the pre-existing tags and the summaries 258 along with a prompt or instruction to the LLM 104 to generate relevant tags 260. FIG. 2B illustrates an example prompt 270a for instructing an LLM to generate tags. This step may leverage the LLM's ability to recognize patterns, identify relationships between entities, and make predictions to create a set of relevant and meaningful tags 260 that (e.g., accurately) represent the video content. In certain embodiments, the tags 260 may include the pre-existing tags as well as additional tags that are generated by the LLM 104 based on the summaries 258. FIG. 2C illustrates an example curated list 270b of tags that includes pre-existing tags and additional tags generated by the LLM 104. In certain scenarios, there may not be any pre-existing tags available to feed into the LLM 104 for use to generate additional tags. Thus, in certain alternate embodiments, the automated platform 102 may provide (e.g., only) summaries 258 along with a modified prompt or instruction to the LLM 104 to generate relevant tags. In these embodiments, the tags 260 may (e.g., only) include those that the LLM 104 generated. In some embodiments, the automated platform 102 may cause the LLM 104 to generate tags 260 directly from the transcripts 256—i.e., without undergoing the intermediate step of generating summaries 258.

For a given video (which may or may not have been included in the initial random sample set discussed above), the automated platform 102 may provide the tags 260 and a corresponding summary 258-1 of that video along with a prompt or instruction to the LLM 104 to select appropriate tag(s) 260-1 from the set of tags 260 that (e.g., best) correspond to the summary 258-1. In certain embodiments, the automated platform 102 may additionally provide a corresponding title of that video to the LLM 104. FIG. 2D illustrates an example prompt 270c for instructing an LLM to select/apply tags for a video. If the video is not part of the initial random sample set, the summary 258-1 may be generated in a manner similar to that described above (e.g., by way of audio extraction, speech-to-text conversion, and summary derivation). Tag selection may be performed for one or more videos (generally, summary 258-n and selected tags 260-n, for ‘n’ videos), such as all videos in the database or file system, all videos in the database or file system other than those in the aforementioned random sample set, or each video that is newly-added or newly-uploaded to the database or file system (e.g., in real-time or near real-time). FIGS. 2E to 2G illustrate various examples (270d, 270e, and 270f) of selected/applied tags for different videos based on their titles and descriptions. Where the videos are accessible via or hosted on a web-based system, the automated platform 102 may store, for each video in the database or file system, the selected/applied tags such that those tags are presented on the video's web page when accessed.

In one or more embodiments, the automated platform 102 may vary the length of a generated summary 258-n of a video based on a level of success in the selection of tags from the tags 260 to apply to that video. For instance, the automated platform 102 may (e.g., by default) cause the LLM 104 to generate summaries 258-n of videos that are limited to a predetermined length (e.g., a first number of tokens or characters). Where the automated platform 102 determines that, during an initial attempt to select tags from tags 260 to apply to a particular video, none of the tags in tags 260 matches or corresponds to the title and/or summary 258-n of that video (e.g., a similarity score between each tag in tags 260 and the content in the title and/or summary 258-n is less than a first threshold), the automated platform 102 may cause the LLM 104 to re-generate a longer summary 258-n for that video (i.e., to include more than the first number of tokens or characters, but less than a second number of tokens or characters). If the automated platform 102 determines that, during a subsequent attempt to select tags from tags 260 to apply to the video, still none of the tags in tags 260 matches or corresponds to the title and/or re-generated summary 258-n of the video (e.g., a similarity score between each tag in tags 260 and the content in the title and/or re-generated summary 258-n is less than a higher, second threshold), the automated platform 102 may cause the LLM 104 to re-generate a yet longer summary 258-n for the video (i.e., to include more than the second number of tokens or characters, but less than a third number of tokens or characters). The automated platform 102 may repeat this process until at least one tag in tags 260 matches or corresponds to the title and/or a then relevant, re-generated summary 258-n of the video (i.e., of length greater than ‘x’ tokens or characters), or until a predefined maximum summary length is reached. If the former case, the automated platform 102 may cause the LLM 104 to generate longer summaries 258-n (i.e., that include more than ‘x’ tokens or characters) for one or more future or subsequent videos to which tags are to be applied. If the latter case, the automated platform 102 may cause a prompt to be provided to a user to input one or more relevant tags for the video to be applied to the video. Here, the automated platform 102 may add the user-inputted tag(s) to the tags 260. Alternatively, the automated platform 102 may prompt the LLM 104 or another LLM 104 to generate one or more new tags to be added to the list of tags 260. Thus, in normal or typical circumstances, the automated platform 102 may successfully select tags from tags 260 to apply to a given video. However, in the (e.g., abnormal) scenario where a threshold difference between the tags 260 and the title and/or summary 258-n of the video is detected (i.e., where no matching or corresponding tags can be selected from the tags 260), the automated platform 102 may trigger automatic re-generation of the summary 258-n of the video and iterative attempt(s) at tag selection until relevant tag(s) from tags 260 can be selected or until a “break out” point is reached, in which case a user may be prompted to provide suitable tag(s) or new tag(s) may be generated by one or more LLMs 104 and added to the list of tags 260.

While various aspects of the tag generation and application process have been described above as involving prompting of an LLM 104, it is to be understood and appreciated that such prompting may be predefined or pre-programmed for the automated platform 102 to perform, and thus the entirety of the tag generation and application process, including subsequent tag application iterations for newly-added videos, may be performed without manual intervention.

Also, while the tag generation and application process has been described above as involving a single LLM 104, in various embodiments, different LLMs 104 may be utilized for different phases of the process or depending on various factors, such as the size or length of a transcript 256. For instance, a first LLM 104 may have a first context window size limit (e.g., a first token/character maximum), and a second LLM 104 may have a second context window size limit (e.g., a second token/character maximum) that is lower than the first context window size limit. In a case where a sample video has a short enough duration such that the context (e.g., token/character count) of a resulting transcript thereof does not exceed the second context window size limit, the automated platform 102 may select the second LLM 104 to generate the summary 258 (or 258-n) for that sample video. In a different case, where a sample video has a long enough duration such that the context (e.g., token/character count) of a resulting transcript thereof exceeds the second context window size limit, but does not exceed the first context window size limit, the automated platform 102 may select the first LLM 104 to generate the summary 258 (or 258-n) for that sample video. As another example, a first LLM 104 may be utilized to generate summaries 258 based on transcripts 256, a second LLM 104 may be utilized to generate tags 260 based on the summaries 258, and/or a third LLM 104 may be utilized to select tags from tags 260 to apply to one or more videos. As a further example, a first LLM 104 may be utilized to generate summaries 258 based on transcripts 256, and a second LLM 104 may be utilized to generate tags 260 based on the summaries 258 and select tags from tags 260 to apply to one or more videos.

It is to be understood and appreciated that, although one or more of FIGS. 1A to 1C and 2A to 2G might be described above as pertaining to various processes and/or actions that are performed in a particular order, some of these processes and/or actions may occur in different orders and/or concurrently with other processes and/or actions from what is depicted and described above. Moreover, not all of these processes and/or actions may be required to implement the systems and/or methods described herein. Furthermore, while various platforms, models, devices, components, modules, systems, blocks, etc. may have been illustrated in one or more of FIGS. 1A to 1C and 2A to 2G as separate platforms, models, devices, components, modules, systems, blocks, etc., it will be appreciated that multiple platforms, models, devices, components, modules, systems, blocks, etc. can be implemented as a single platform, model, device, component, module, system, block, etc., or a single platform, model, device, component, module, system, block, etc. can be implemented as multiple platforms, models, devices, components, modules, systems, blocks, etc. Additionally, functions described as being performed by one platform, model, device, component, module, system, block, etc. may be performed by multiple platforms, models, devices, components, modules, systems, blocks, etc., or functions described as being performed by multiple platforms, models, devices, components, modules, systems, blocks, etc. may be performed by a single platform, model, device, component, module, system, block, etc.

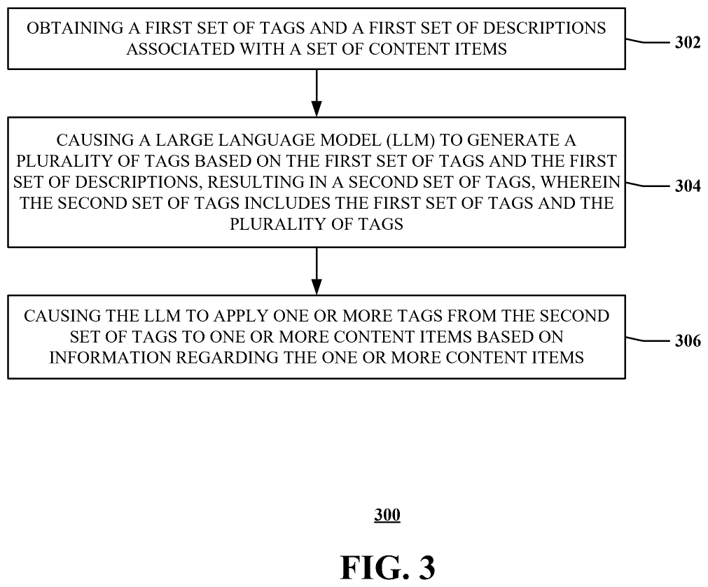

FIG. 3 depicts an illustrative embodiment of a method 300 in accordance with various aspects described herein.

At 302, the method can include obtaining a first set of tags and a first set of descriptions associated with a set of content items. For example, the automated platform 102 may, similar to that described above with respect to one or more of FIGS. 2A to 2G, perform one or more operations that include obtaining a first set of tags and a first set of descriptions associated with a set of content items.

At 304, the method can include causing an LLM to generate a plurality of tags based on the first set of tags and the first set of descriptions, resulting in a second set of tags, wherein the second set of tags includes the first set of tags and the plurality of tags. For example, the automated platform 102 may, similar to that described above with respect to one or more of FIGS. 2A to 2G, perform one or more operations that include causing an LLM 104 to generate a plurality of tags based on the first set of tags and the first set of descriptions, resulting in a second set of tags, wherein the second set of tags includes the first set of tags and the plurality of tags.

At 306, the method can include causing the LLM to apply one or more tags from the second set of tags to one or more content items based on information regarding the one or more content items. For example, the automated platform 102 may, similar to that described above with respect to one or more of FIGS. 2A to 2G, perform one or more operations that include causing the LLM 104 to apply one or more tags from the second set of tags to one or more content items based on information regarding the one or more content items.

While for purposes of simplicity of explanation, the respective processes are shown and described as a series of blocks in FIG. 3, it is to be understood and appreciated that the claimed subject matter is not limited by the order of the blocks, as some blocks may occur in different orders and/or concurrently with other blocks from what is depicted and described herein. Moreover, not all illustrated blocks may be required to implement the methods described herein.

Turning now to FIG. 4, there is illustrated a block diagram of a computing environment in accordance with various aspects described herein. In order to provide additional context for various embodiments of the embodiments described herein, FIG. 4 and the following discussion are intended to provide a brief, general description of a suitable computing environment 400 in which the various embodiments of the subject disclosure can be implemented. For example, computing environment 400 can facilitate, in whole or in part, automated tag generation and application for content items, such as video content, audio content, text-based content, etc.

Generally, program modules comprise routines, programs, components, data structures, etc., that perform particular tasks or implement particular abstract data types. Moreover, those skilled in the art will appreciate that the methods can be practiced with other computer system configurations, comprising single-processor or multiprocessor computer systems, minicomputers, mainframe computers, as well as personal computers, hand-held computing devices, microprocessor-based or programmable consumer electronics, and the like, each of which can be operatively coupled to one or more associated devices.

As used herein, a processing circuit includes one or more processors as well as other application specific circuits such as an application specific integrated circuit, digital logic circuit, state machine, programmable gate array or other circuit that processes input signals or data and that produces output signals or data in response thereto. It should be noted that while any functions and features described herein in association with the operation of a processor could likewise be performed by a processing circuit.

The illustrated embodiments of the embodiments herein can be also practiced in distributed computing environments where certain tasks are performed by remote processing devices that are linked through a communications network. In a distributed computing environment, program modules can be located in both local and remote memory storage devices.

Computing devices typically comprise a variety of media, which can comprise computer-readable storage media and/or communications media, which two terms are used herein differently from one another as follows. Computer-readable storage media can be any available storage media that can be accessed by the computer and comprises both volatile and nonvolatile media, removable and non-removable media. By way of example, and not limitation, computer-readable storage media can be implemented in connection with any method or technology for storage of information such as computer-readable instructions, program modules, structured data or unstructured data.

Computer-readable storage media can comprise, but are not limited to, random access memory (RAM), read only memory (ROM), electrically erasable programmable read only memory (EEPROM), flash memory or other memory technology, compact disk read only memory (CD ROM), digital versatile disk (DVD) or other optical disk storage, magnetic cassettes, magnetic tape, magnetic disk storage or other magnetic storage devices or other tangible and/or non-transitory media which can be used to store desired information. In this regard, the terms “tangible” or “non-transitory” herein as applied to storage, memory or computer-readable media, are to be understood to exclude only propagating transitory signals per se as modifiers and do not relinquish rights to all standard storage, memory or computer-readable media that are not only propagating transitory signals per se.

Computer-readable storage media can be accessed by one or more local or remote computing devices, e.g., via access requests, queries or other data retrieval protocols, for a variety of operations with respect to the information stored by the medium.

Communications media typically embody computer-readable instructions, data structures, program modules or other structured or unstructured data in a data signal such as a modulated data signal, e.g., a carrier wave or other transport mechanism, and comprises any information delivery or transport media. The term “modulated data signal” or signals refers to a signal that has one or more of its characteristics set or changed in such a manner as to encode information in one or more signals. By way of example, and not limitation, communication media comprise wired media, such as a wired network or direct-wired connection, and wireless media such as acoustic, RF, infrared and other wireless media.

With reference again to FIG. 4, the example environment can comprise a computer 402, the computer 402 comprising a processing unit 404, a system memory 406 and a system bus 408. The system bus 408 couples system components including, but not limited to, the system memory 406 to the processing unit 404. The processing unit 404 can be any of various commercially available processors. Dual microprocessors and other multiprocessor architectures can also be employed as the processing unit 404.

The system bus 408 can be any of several types of bus structure that can further interconnect to a memory bus (with or without a memory controller), a peripheral bus, and a local bus using any of a variety of commercially available bus architectures. The system memory 406 comprises ROM 410 and RAM 412. A basic input/output system (BIOS) can be stored in a non-volatile memory such as ROM, erasable programmable read only memory (EPROM), EEPROM, which BIOS contains the basic routines that help to transfer information between elements within the computer 402, such as during startup. The RAM 412 can also comprise a high-speed RAM such as static RAM for caching data.

The computer 402 further comprises an internal hard disk drive (HDD) 414 (e.g., EIDE, SATA), which internal HDD 414 can also be configured for external use in a suitable chassis (not shown), a magnetic floppy disk drive (FDD) 416, (e.g., to read from or write to a removable diskette 418) and an optical disk drive 420, (e.g., reading a CD-ROM disk 422 or, to read from or write to other high-capacity optical media such as the DVD). The HDD 414, magnetic FDD 416 and optical disk drive 420 can be connected to the system bus 408 by a hard disk drive interface 424, a magnetic disk drive interface 426 and an optical drive interface 428, respectively. The hard disk drive interface 424 for external drive implementations comprises at least one or both of Universal Serial Bus (USB) and Institute of Electrical and Electronics Engineers (IEEE) 1394 interface technologies. Other external drive connection technologies are within contemplation of the embodiments described herein.

The drives and their associated computer-readable storage media provide nonvolatile storage of data, data structures, computer-executable instructions, and so forth. For the computer 402, the drives and storage media accommodate the storage of any data in a suitable digital format. Although the description of computer-readable storage media above refers to a hard disk drive (HDD), a removable magnetic diskette, and a removable optical media such as a CD or DVD, it should be appreciated by those skilled in the art that other types of storage media which are readable by a computer, such as zip drives, magnetic cassettes, flash memory cards, cartridges, and the like, can also be used in the example operating environment, and further, that any such storage media can contain computer-executable instructions for performing the methods described herein.

A number of program modules can be stored in the drives and RAM 412, comprising an operating system 430, one or more application programs 432, other program modules 434 and program data 436. All or portions of the operating system, applications, modules, and/or data can also be cached in the RAM 412. The systems and methods described herein can be implemented utilizing various commercially available operating systems or combinations of operating systems.

A user can enter commands and information into the computer 402 through one or more wired/wireless input devices, e.g., a keyboard 438 and a pointing device, such as a mouse 440. Other input devices (not shown) can comprise a microphone, an infrared (IR) remote control, a joystick, a game pad, a stylus pen, touch screen or the like. These and other input devices are often connected to the processing unit 404 through an input device interface 442 that can be coupled to the system bus 408, but can be connected by other interfaces, such as a parallel port, an IEEE 1394 serial port, a game port, a universal serial bus (USB) port, an IR interface, etc.

A monitor 444 or other type of display device can be also connected to the system bus 408 via an interface, such as a video adapter 446. It will also be appreciated that in alternative embodiments, a monitor 444 can also be any display device (e.g., another computer having a display, a smart phone, a tablet computer, etc.) for receiving display information associated with computer 402 via any communication means, including via the Internet and cloud-based networks. In addition to the monitor 444, a computer typically comprises other peripheral output devices (not shown), such as speakers, printers, etc.

The computer 402 can operate in a networked environment using logical connections via wired and/or wireless communications to one or more remote computers, such as a remote computer(s) 448. The remote computer(s) 448 can be a workstation, a server computer, a router, a personal computer, portable computer, microprocessor-based entertainment appliance, a peer device or other common network node, and typically comprises many or all of the elements described relative to the computer 402, although, for purposes of brevity, only a remote memory/storage device 450 is illustrated. The logical connections depicted comprise wired/wireless connectivity to a local area network (LAN) 452 and/or larger networks, e.g., a wide area network (WAN) 454. Such LAN and WAN networking environments are commonplace in offices and companies, and facilitate enterprise-wide computer networks, such as intranets, all of which can connect to a global communications network, e.g., the Internet.

When used in a LAN networking environment, the computer 402 can be connected to the LAN 452 through a wired and/or wireless communication network interface or adapter 456. The adapter 456 can facilitate wired or wireless communication to the LAN 452, which can also comprise a wireless AP disposed thereon for communicating with the adapter 456.

When used in a WAN networking environment, the computer 402 can comprise a modem 458 or can be connected to a communications server on the WAN 454 or has other means for establishing communications over the WAN 454, such as by way of the Internet. The modem 458, which can be internal or external and a wired or wireless device, can be connected to the system bus 408 via the input device interface 442. In a networked environment, program modules depicted relative to the computer 402 or portions thereof, can be stored in the remote memory/storage device 450. It will be appreciated that the network connections shown are example and other means of establishing a communications link between the computers can be used.

The computer 402 can be operable to communicate with any wireless devices or entities operatively disposed in wireless communication, e.g., a printer, scanner, desktop and/or portable computer, portable data assistant, communications satellite, any piece of equipment or location associated with a wirelessly detectable tag (e.g., a kiosk, news stand, restroom), and telephone. This can comprise Wireless Fidelity (Wi-Fi) and BLUETOOTH® wireless technologies. Thus, the communication can be a predefined structure as with a conventional network or simply an ad hoc communication between at least two devices.

Wi-Fi can allow connection to the Internet from a couch at home, a bed in a hotel room or a conference room at work, without wires. Wi-Fi is a wireless technology similar to that used in a cell phone that enables such devices, e.g., computers, to send and receive data indoors and out; anywhere within the range of a base station. Wi-Fi networks use radio technologies called IEEE 802.11 (a, b, g, n, ac, ag, etc.) to provide secure, reliable, fast wireless connectivity. A Wi-Fi network can be used to connect computers to each other, to the Internet, and to wired networks (which can use IEEE 802.3 or Ethernet). Wi-Fi networks operate in the unlicensed 2.4 and 5 GHz radio bands for example or with products that contain both bands (dual band), so the networks can provide real-world performance similar to the basic 10BaseT wired Ethernet networks used in many offices.

In various embodiments, threshold(s) may be utilized as part of determining/identifying one or more actions to be taken or engaged. The threshold(s) may be adaptive based on an occurrence of one or more events or satisfaction of one or more conditions (or, analogously, in an absence of an occurrence of one or more events or in an absence of satisfaction of one or more conditions).

What has been described above includes mere examples of various embodiments. It is, of course, not possible to describe every conceivable combination of components or methodologies for purposes of describing these examples, but one of ordinary skill in the art can recognize that many further combinations and permutations of the present embodiments are possible. Accordingly, the embodiments disclosed and/or claimed herein are intended to embrace all such alterations, modifications and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim. It is also to be understood and appreciated that the subject matter in one or more dependent claims may be combined with that in one or more other dependent claims.

Computing devices typically comprise a variety of media, which can comprise computer-readable storage media and/or communications media, which two terms are used herein differently from one another as follows. Computer-readable storage media can be any available storage media that can be accessed by the computer and comprises both volatile and nonvolatile media, removable and non-removable media. By way of example, and not limitation, computer-readable storage media can be implemented in connection with any method or technology for storage of information such as computer-readable instructions, program modules, structured data or unstructured data. Computer-readable storage media can comprise the widest variety of storage media including tangible and/or non-transitory media which can be used to store desired information. In this regard, the terms “tangible” or “non-transitory” herein as applied to storage, memory or computer-readable media, are to be understood to exclude only propagating transitory signals per se as modifiers and do not relinquish rights to all standard storage, memory or computer-readable media that are not only propagating transitory signals per se.

In addition, a flow diagram may include a “start” and/or “continue” indication. The “start” and “continue” indications reflect that the steps presented can optionally be incorporated in or otherwise used in conjunction with other routines. In this context, “start” indicates the beginning of the first step presented and may be preceded by other activities not specifically shown. Further, the “continue” indication reflects that the steps presented may be performed multiple times and/or may be succeeded by other activities not specifically shown. Further, while a flow diagram indicates a particular ordering of steps, other orderings are likewise possible provided that the principles of causality are maintained.

As may also be used herein, the term(s) “operably coupled to”, “coupled to”, and/or “coupling” includes direct coupling between items and/or indirect coupling between items via one or more intervening items. Such items and intervening items include, but are not limited to, junctions, communication paths, components, circuit elements, circuits, functional blocks, and/or devices. As an example of indirect coupling, a signal conveyed from a first item to a second item may be modified by one or more intervening items by modifying the form, nature or format of information in a signal, while one or more elements of the information in the signal are nevertheless conveyed in a manner than can be recognized by the second item. In a further example of indirect coupling, an action in a first item can cause a reaction on the second item, as a result of actions and/or reactions in one or more intervening items.

Although specific embodiments have been illustrated and described herein, it should be appreciated that any arrangement which achieves the same or similar purpose may be substituted for the embodiments described or shown by the subject disclosure. The subject disclosure is intended to cover any and all adaptations or variations of various embodiments. Combinations of the above embodiments, and other embodiments not specifically described herein, can be used in the subject disclosure. For instance, one or more features from one or more embodiments can be combined with one or more features of one or more other embodiments. In one or more embodiments, features that are positively recited can also be negatively recited and excluded from the embodiment with or without replacement by another structural and/or functional feature. The steps or functions described with respect to the embodiments of the subject disclosure can be performed in any order. The steps or functions described with respect to the embodiments of the subject disclosure can be performed alone or in combination with other steps or functions of the subject disclosure, as well as from other embodiments or from other steps that have not been described in the subject disclosure. Further, more than or less than all of the features described with respect to an embodiment can also be utilized. It is also to be understood and appreciated that the subject matter in one or more dependent claims may be combined with that in one or more other dependent claims.

What is claimed is:

1. A device, comprising:
a processing system including a processor; and
a memory that stores executable instructions that, when executed by the processing system, facilitate performance of operations, the operations comprising:
obtaining a first set of tags and a first set of descriptions associated with a set of content items;
causing a large language model (LLM) to generate a plurality of tags based on the first set of tags and the first set of descriptions, resulting in a second set of tags, wherein the second set of tags includes the first set of tags and the plurality of tags; and
causing the LLM to apply one or more tags from the second set of tags to one or more content items based on information regarding the one or more content items.

2. The device of claim 1, wherein the set of content items comprise video content, audio content, text-based content, or a combination thereof.

3. The device of claim 1, wherein the set of content items comprise videos, and wherein the operations further comprise deriving the first set of descriptions by:
extracting audio data from the videos using one or more audio extraction algorithms; and
converting the audio data into text using one or more speech recognition algorithms.

4. The device of claim 1, wherein the set of content items comprises a random sample set of content items included in a content database or a file system.

5. The device of claim 1, wherein the information comprises one or more titles associated with the one or more content items, one or more descriptions or summaries associated with the one or more content items, or a combination thereof.

6. The device of claim 1, wherein one or more of the causing the LLM to generate the plurality of tags and the causing the LLM to apply the one or more tags are performed using one or more application programming interface (API) requests.

7. The device of claim 1, wherein one or more of the causing the LLM to generate the plurality of tags and the causing the LLM to apply the one or more tags are based on inputting of one or more prompts to the LLM.

8. The device of claim 1, wherein the LLM is pre-trained on a corpus of data and finetuned or instruction-tuned for responding to prompts.

9. The device of claim 1, wherein the one or more content items are stored in a content database or a file system, and wherein the operations further comprise, for at least one content item of the one or more content items, storing, in the content database or the file system, at least one tag that is applied to the at least one content item as a result of the causing the LLM to apply the one or more tags.

10. A non-transitory machine-readable medium, comprising executable instructions that, when executed by a processing system including a processor, facilitate performance of operations, the operations comprising:
receiving a first set of tags and a first set of descriptions associated with a set of videos;
instructing a large language model (LLM) to generate a plurality of tags based on the first set of tags and the first set of descriptions, resulting in a second set of tags, wherein the second set of tags includes the first set of tags and the plurality of tags; and
instructing the LLM to apply one or more tags from the second set of tags to one or more videos based on information regarding the one or more videos.

11. The non-transitory machine-readable medium of claim 10, wherein the operations further comprise deriving the first set of descriptions by:
extracting audio data from the set of videos using one or more audio extraction algorithms; and
converting the audio data into text using one or more speech recognition algorithms.

12. The non-transitory machine-readable medium of claim 10, wherein the set of videos comprises a random sample set of videos included in a content database or a file system.

13. The non-transitory machine-readable medium of claim 10, wherein the information comprises one or more titles associated with the one or more videos, one or more descriptions or summaries associated with the one or more videos, or a combination thereof.

14. The non-transitory machine-readable medium of claim 10, wherein one or more of the instructing the LLM to generate the plurality of tags and the instructing the LLM to apply the one or more tags are performed using one or more application programming interface (API) requests.

15. The non-transitory machine-readable medium of claim 10, wherein one or more of the instructing the LLM to generate the plurality of tags and the instructing the LLM to apply the one or more tags are based on inputting of one or more prompts to the LLM.

16. The non-transitory machine-readable medium of claim 10, wherein the LLM is pre-trained on a corpus of data and finetuned or instruction-tuned for responding to prompts.

17. The non-transitory machine-readable medium of claim 10, wherein the one or more videos are stored in a content database or a file system, and wherein the operations further comprise, for at least one video of the one or more videos, storing, in the content database or the file system, at least one tag that is applied to the at least one video as a result of the instructing the LLM to apply the one or more tags.

18. A method, comprising:
obtaining, by a processing system including a processor, a first set of tags and a first set of descriptions associated with a set of content items;
causing, by the processing system, a first large language model (LLM) to generate a plurality of tags based on the first set of tags and the first set of descriptions, resulting in a second set of tags, wherein the second set of tags includes the first set of tags and the plurality of tags; and
causing, by the processing system, a second LLM to apply one or more tags from the second set of tags to one or more content items based on information regarding the one or more content items.

19. The method of claim 18, wherein the second LLM is the first LLM.

20. The method of claim 18, wherein the first LLM is different from the second LLM.
